(19) United States
(12) Patent Application Publication
(10) Pub. No.: US 2015/0331415 A1
(43) Pub. Date: Nov. 19, 2015

(54) ROBOTIC TASK DEMONSTRATION INTERFACE

(71) Applicant: Microsoft Corporation, Redmond, WA (US)

(72) Inventors: Ashley Nathan Feniello, Duvall, WA (US); Stan Birchfield, Sammamish, WA (US); Hao Dang, Redmond, WA (US)

(73) Assignee: Microsoft Corporation, Redmond, WA (US)

(21) Appl. No.: 14/280,125

(22) Filed: May 16, 2014

(51) Int. Cl. G05B 19/425; B25J 9/16

(52) U.S. Cl. CPC G05B 19/425; B25J 9/1661; Y10S 901/05

(57) ABSTRACT

Robotic task demonstration interface embodiments are presented that generally employ a user interface to synthesize a robotic control program based on user demonstrations of object repositioning tasks, where the user manipulates objects in a displayed workspace to indicate what tasks that it is desired for a robot to perform on objects in the actual workspace associated with the robot. For example, this can involve a user repositioning objects displayed on a touch screen of a tablet computer. The configuration of the displayed workspace can be changed and additional repositioning examples performed. A robotic control program is synthesized for instructing the robot to perform the tasks indicated in the object repositioning demonstrations. The resulting learned robotic control program can be executed virtually for validation purposes, before applying it to the robot.

### BACKGROUND

Traditionally, tasks to be performed by a robot are programmed by roboticists and are meant to be executed in controlled (caged) environments. More recently, “learning by demonstration” methods have been developed. Learning by demonstration is an important paradigm for teaching robots to carry out tasks. Many task learning systems (e.g., program synthesis) require a set of examples in which a human operator specifies the exact trajectories that are to be carried out by the robot for a particular workspace arrangement. This set of example tasks is accomplished via teleoperation and/or direct manipulation of the robot. Once these trajectories are learned, the robot essentially mimics the human operator's demonstrations.

### SUMMARY

Robotic task demonstration interface embodiments described herein generally employ a user interface to synthesize a robotic control program based on user demonstrations of object repositioning tasks, where the user manipulates objects in a displayed workspace. In one implementation, this is accomplished using a computer system that includes a user interface and a display device. First, the computer system receives object data. This data represents a collection of objects characterized by their orientation, location and perceptual properties in a workspace associated with a robot. A virtual rendering of the workspace is displayed in which the collection of objects is depicted so as to reflect the orientation, location and perceptual properties found in the object data. The displayed objects from the collection are capable of being repositioned so as to be depicted in a different orientation, or location, or both within the virtual rendering of the workspace. In one implementation, the virtual rendering of the workplace and objects are displayed on a touch screen display, and the displayed objects are repositioned via touch gestures on the touch screen display. The computer system next receives user instructions to reposition one or more of the depicted objects for the collection. The object repositioning instructions are indicative of tasks that it is desired for a robot to perform on an object or objects in an actual workspace associated with the robot. However, the tasks are demonstrated without manipulating real world objects. In the implementation employing a touch screen display, the user instructions are received in response to user interaction with the touch screen. A robotic control program is then synthesized for instructing the robot to perform the tasks indicated in the received object repositioning instructions.

Robotic task demonstration interface embodiments described herein also allow for multiple sets of repositioning demonstrations to be performed, and for the resulting learned robotic control program to be executed virtually for validation purposes, before applying it to the robot. In one implementation, one or more additional sets of repositioning demonstrations are received before the robotic control program is synthesized and in one implementation additional repositioning demonstrations are received after the robotic control program is synthesized and virtually executed. In these implementation involving additional repositioning instructions, a new virtual rendering of the workspace is displayed in which a collection of objects characterized by their orientation, location and perceptual properties are depicted. The additional user instructions to reposition one or more of the objects depicted in the new virtual rendering of the workspace are then received. Once again, the object repositioning instructions are indicative of tasks that it is desired for the robot to perform on an object or objects in the actual workspace. A robotic control program is then synthesized for instructing the robot to perform the tasks indicated in the additional object repositioning instructions and previously-received object repositioning instructions.

It should also be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

The specific features, aspects, and advantages of the disclosure will become better understood with regard to the following description, appended claims, and accompanying drawings where:

FIG. 1 is a simplified diagram of a suitable environment for practicing robotic task demonstration interface embodiments described herein.

FIG. 2 is a flow diagram illustrating an exemplary embodiment, in simplified form, of a process for employing a robotics tasks demonstration interface to synthesize a robotic control program.

FIG. 3 is a flow diagram illustrating an exemplary embodiment, in simplified form, of a process for employing a robotics tasks demonstration interface to synthesize a robotic control program where a user performs multiple sets of repositioning demonstrations before the robotic control program is synthesized.

FIGS. 4A-B show a flow diagram illustrating an exemplary embodiment, in simplified form, of a process for employing a robotics tasks demonstration interface to synthesize a robotic control program where a user is not satisfied with the operation of a previously-synthesized program and additional repositioning demonstrations are performed before the program re-synthesized.

FIG. 5 is a simplified diagram of a virtual workspace training interface.

FIGS. 6A-B show a flow diagram illustrating an exemplary embodiment, in simplified form, of a process for employing a robotics tasks demonstration interface to synthesize a robotic control program where the user employs the touch screen to move objects and/or change the pose of objects.

FIG. 7 is a diagram depicting a general purpose computing device constituting an exemplary system for implementing robotic task demonstration interface embodiments described herein.

### DETAILED DESCRIPTION

In the following description of robotic task demonstration interface embodiments reference is made to the accompanying drawings which form a part hereof, and in which are shown, by way of illustration, specific embodiments in which the technique may be practiced. It is understood that other embodiments may be utilized and structural changes may be made without departing from the scope of the interface.

It is also noted that for the sake of clarity specific terminology will be resorted to in describing the robotic task demonstration interface embodiments described herein and it is not intended for these embodiments to be limited to the specific terms so chosen. Furthermore, it is to be understood that each specific term includes all its technical equivalents that operate in a broadly similar manner to achieve a similar purpose. Reference herein to “one embodiment”, or “another embodiment”, or an “exemplary embodiment”, or an “alternate embodiment”, or “one implementation”, or “another implementation”, or an “exemplary implementation”, or an “alternate implementation” means that a particular feature, a particular structure, or particular characteristics described in connection with the embodiment or implementation can be included in at least one embodiment of the robotic task demonstration interface. The appearances of the phrases “in one embodiment”, “in another embodiment”, “in an exemplary embodiment”, “in an alternate embodiment”, “in one implementation”, “in another implementation”, “in an exemplary implementation”, and “in an alternate implementation” in various places in the specification are not necessarily all referring to the same embodiment or implementation, nor are separate or alternative embodiments/implementations mutually exclusive of other embodiments/implementations. Yet furthermore, the order of process flow representing one or more embodiments or implementations of the robotic task demonstration interface does not inherently indicate any particular order not imply any limitations of the interface.

### 1.0 Robotic Task Demonstration Interface

The robotic task demonstration interface embodiments described herein generally employ a user interface to synthesize a robotic control program based on user demonstrations of object repositioning tasks (e.g. sorting, kitting, or packaging), where the user manipulates objects in a displayed workspace. The following sections will provided more detail about the environment and processes involved in implementing the embodiments of the robotic task demonstration interface.

### 1.1 Robotic Task Demonstration Interface Environment

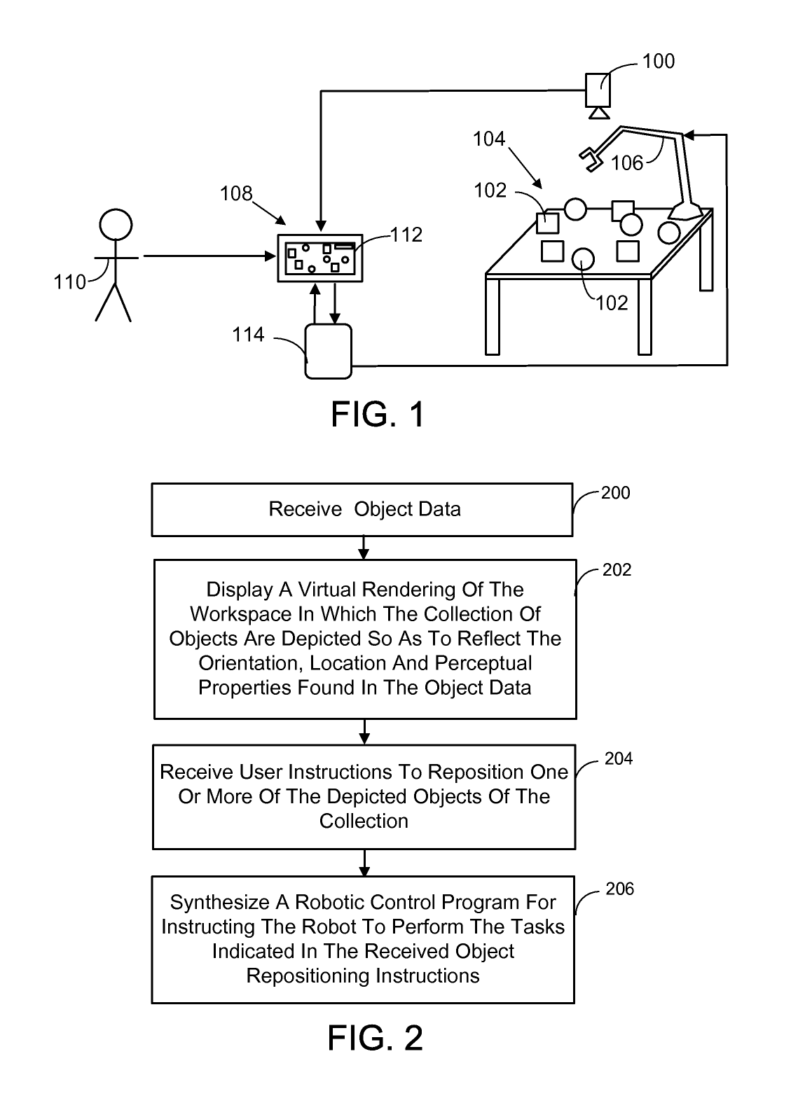

Before the robotic task demonstration interface embodiments are described, a general description of a suitable environment in which portions thereof may be implemented will be described. Referring to FIG. 1, a digital camera 100 is used to capture images of the workspace 104 of the robot 106. The captured images are used to detect the objects 102 in the workspace 104, along with their perceptual properties, using conventional methods. In addition, a background view of the workspace is derived from the images, also using conventional methods. A computing device 108 having an associated screen display (such as by way of example, and not limitation, a tablet computer having a touch screen display) runs a robotics tasks demonstration interface computer program on which a user 110 demonstrates repositioning tasks in a displayed virtual rendering of the robot's workspace 112. The displayed virtual workspace rendering 112 is generated from the aforementioned workspace background and detected objects. Based on one or more demonstrations, a synthesized program 114 is generated that is used to accomplish the tasks in the actual workspace, even with an arrangement of objects different from the training inputs. It is noted that during training, the user 110 can interactively provide repositioning task examples while viewing the behavior of the synthesized program the computing device 108, without actually controlling the robot 106, as will be described in more detail later.

### 1.2 Robotic Task Demonstration Interface Processes

In view of the foregoing environment, one general implementation of the robotic task demonstration interface embodiments described herein is accomplished by using a computing device to perform the following process actions. Referring to FIG. 2, object data is received (process action 200). This data represents a collection of objects characterized by their orientation, location and perceptual properties in a workspace associated with a robot. In one implementation, the object data is generated using a camera to detect actual objects in the workspace of the robot, along with their visual properties (e.g., size, dimensions, color, and so on). Thus, in a sense, this data is a view into the real world reflecting what the robot is capable of perceiving. Any appropriate perception system can be used to derive the orientation, location and visual properties of each object, along with the workspace background, from the camera images. In another implementation, one or more of the objects included in the object data are obtained from a previously-established database of virtual objects. These database objects can come from previously-captured actual images of a robot's workspace, or they can be synthesized using conventional methods. In yet another implementation, the object data is synthesized using conventional methods. This synthesized workspace depicts either virtual objects synthesized from actual images of a robot's workspace, or synthesized objects that where specifically generated for the synthesized workspace, or synthesized objects obtained from the aforementioned database of virtual objects.

Referring again to FIG. 2, a virtual rendering of the workspace is displayed in which the collection of objects are depicted so as to reflect the orientation, location and perceptual properties found in the object data (process action 202). Each of the displayed objects from the collection is capable of being repositioned so as to be depicted in a different orientation, or location, or both within the virtual rendering of the workspace. In one implementation, the virtual rendering of the workplace and objects are displayed on a touch screen display. In addition, while any computer able to host the user interface and which has a display, can be employed (such as those described in the Exemplary Operating Environments section of this specification), in one implementation a tablet computer having a touch screen display is used.

Next, user instructions to reposition one or more of the depicted objects of the collection are received (process action 204). The object repositioning instructions are indicative of tasks that it is desired for the robot to perform on an object or objects in an actual workspace associated with the robot. However, the tasks are demonstrated without manipulating real world objects. In one implementation, the object repositioning instructions are generated via a touch gesture on the aforementioned touch screen display, as will be described in more detail later.

Referring once again to FIG. 2, a robotic control program is synthesized for instructing the robot to perform the tasks indicated in the received object repositioning instructions (process action 206). Any appropriate learning-by-demonstration robotic control program synthesis method can be employed for this task.

### 1.2.1 Additional Repositioning Instructions And Program Validation

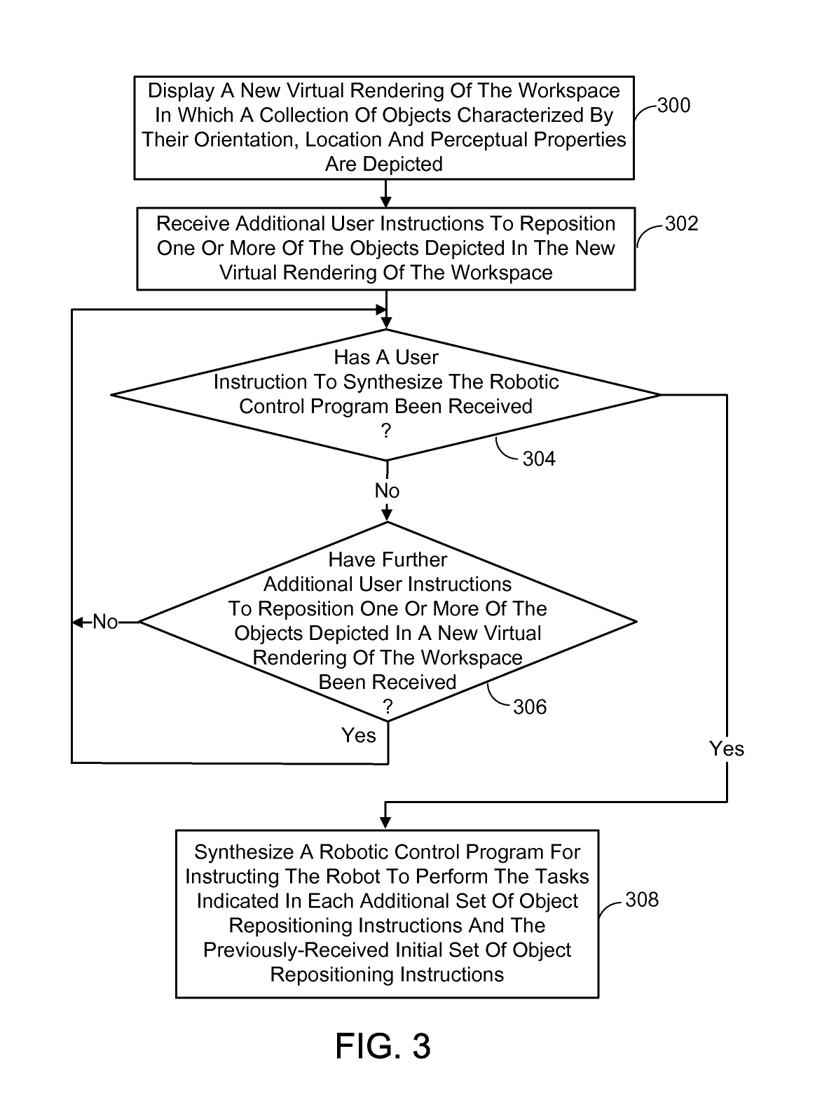

Robotic task demonstration interface embodiments described herein also allow for multiple sets of repositioning demonstrations to be performed during training, and for the resulting learned robotic control program to be validated virtually, before applying it to the robot. In one implementation, the user performs multiple sets of repositioning demonstrations before the robotic control program is synthesized. For instance, in one exemplary implementation this is accomplished by performing process actions 200 through 204 of FIG. 2, but rather than synthesizing the robotic control program as shown in process action 206, the following process is performed instead. Referring to FIG. 3, a new virtual rendering of the workspace is displayed in which a collection of objects characterized by their orientation, location and perceptual properties are depicted (process action 300). Additional user instructions to reposition one or more of the objects depicted in the new virtual rendering of the workspace are then received (process action 302). As before, the object repositioning instructions are indicative of tasks that it is desired for the robot to perform on an object or objects in the actual workspace, and represent a new set of repositioning demonstrations. It is next determined if a user instruction to synthesize the robotic control program has been received (process action 304). If not, it is determined in process action 306 if further additional user instructions to reposition one or more of the objects depicted in a new virtual rendering of the workspace have been received. If not, the monitoring for either a synthesize instruction or an additional set of repositioning instructions continues. Similarly, if it is determined in process action 306 that an additional set of repositioning instructions has been received, the monitoring for either a synthesize instruction or yet another additional set of repositioning instructions continues. The monitoring actions end when it is determined in process action 304 that a user instruction to synthesize the robotic control program has been received. At that point, a robotic control program is synthesized for instructing the robot to perform the tasks indicated in each additional set of object repositioning instructions and the previously-received initial set of object repositioning instructions (process action 308).

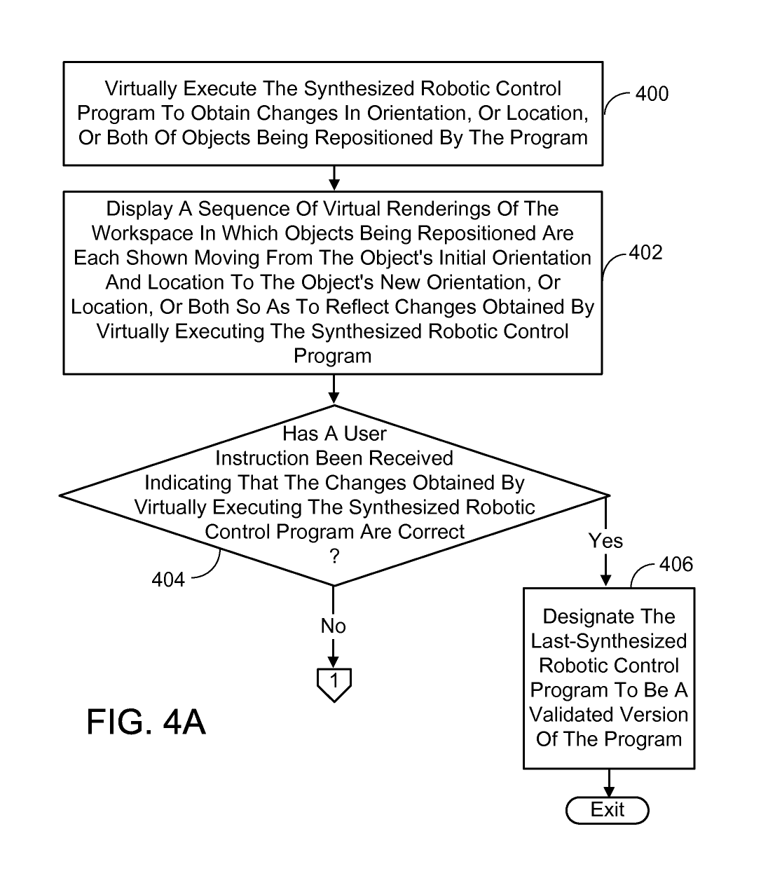

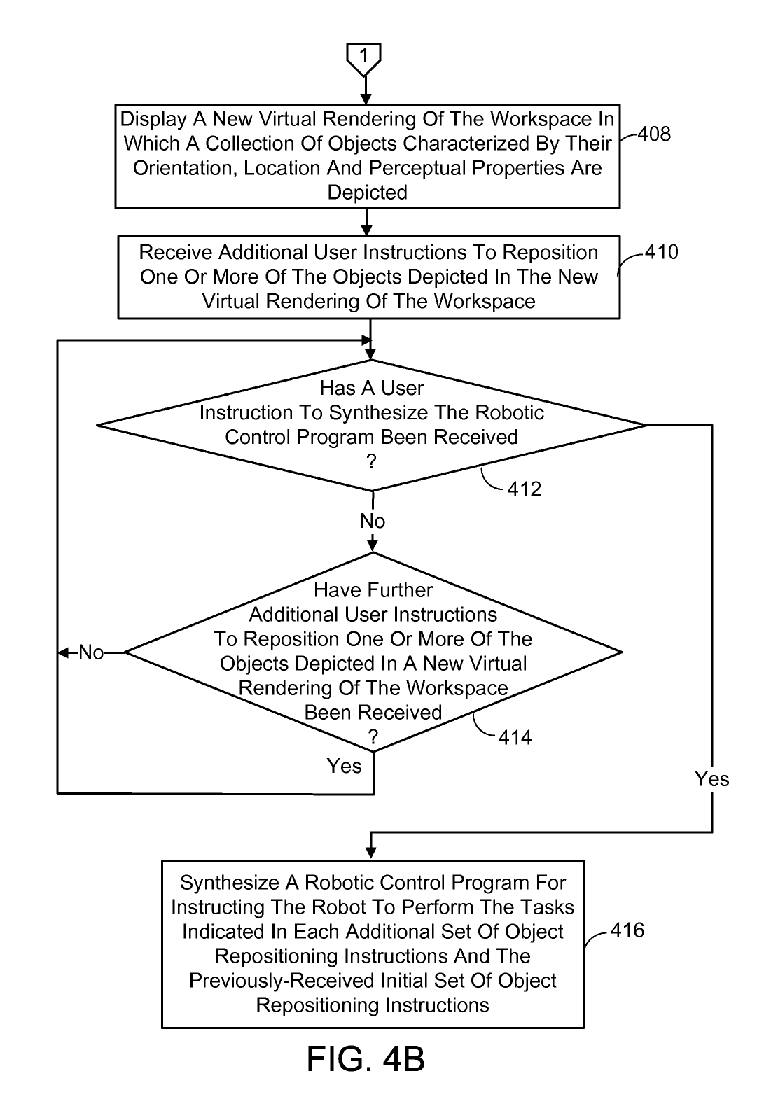

In another implementation, the robotic control program is synthesized and played virtually. In this latter implementation, if the user is satisfied, then the program is deemed validated. However, if the user is not satisfied with the operation of the program, additional repositioning demonstrations can be performed and the program re-synthesized. This can continue until the last-synthesized robotic control program is played and the user is satisfied with its operation. For instance, in one exemplary implementation this is accomplished by performing process actions 200 through 206 of FIG. 2. Next, referring to FIGS. 4A-B, the synthesized robotic control program is virtually executed to obtain changes in orientation, or location, or both of objects being repositioned by the program (process action 400). A sequence of virtual renderings of the workspace is displayed in which objects being repositioned are each shown moving from the object's initial orientation and location to the object's new orientation, or location, or both so as to reflect changes obtained by virtually executing the synthesized robotic control program (process action 402). It is then determined if a user instruction is received indicating the changes in orientation, or location, or both of one or more objects as obtained by virtually executing the synthesized robotic control program are correct (process action 404). If so, the last-synthesized robotic control program is designated to be a validated version of the program (process action 406), and the process ends. However, if a user instruction indicating the changes are correct is not received, a new virtual rendering of the workspace is displayed in which a collection of objects characterized by their orientation, location and perceptual properties are depicted (process action 408). Additional user instructions to reposition one or more of the objects depicted in the new virtual rendering of the workspace are then received (process action 410). As before, the object repositioning instructions are indicative of tasks that it is desired for the robot to perform on an object or objects in the actual workspace, and represent a new set of repositioning demonstrations. It is next determined if a user instruction to synthesize the robotic control program has been received (process action 412). If not, it is determined in process action 414 if additional user instructions to reposition one or more of the objects depicted in a new virtual rendering of the workspace have been received. If not, the monitoring for either a synthesize instruction or an additional set of repositioning instructions continues. Similarly, if it is determined in process action 414 that an additional set of repositioning instructions has been received, the monitoring for either a synthesize instruction or yet another additional set of repositioning instructions continues. The monitoring actions end when it is determined in process action 412 that a user instruction to synthesize the robotic control program has been received. At that point, a revised robotic control program is synthesized for instructing the robot to perform the tasks indicated in each additional set of object repositioning instructions and the previously-received initial set of object repositioning instructions (process action 416). The process of FIGS. 4A-B can then be repeated until the user is satisfied with the last-synthesized robotic control program and it is designated to be a validated version of the program.

It is noted that the foregoing implementations can be combined in any order. Thus, for example, a user might provided multiple sets of object repositioning instructions prior to causing a robotic control program to be synthesized, and then upon virtually executing the program decide it is not yet correct and provide one of more additional sets of object repositioning instructions, until a resulting version of the program is deemed correct.

### 1.2.1.1 New Virtual Workspace Rendering

In foregoing implementations, repositioning demonstrations performed after the initial repositioning of one or more of the depicted objects were said to be performed using a new virtual rendering of the workspace. A new virtual rendering of the robot's workspace can be accomplished in a variety of ways. In one implementation, an image of an actual workspace associated with a robot is captured and employed to produce the new virtual workspace rendering. If a previous workspace rendering was generated using an image of the actual workspace, the objects could be physically rearranged (or new object introduced, or old objects removed) prior to the new image being captured. In another implementation, a newly generated or previously rendered virtual workspace could be modified to create a new virtual workspace rendering—thus negating the need to physically rearrange the workspace. For example, the orientation or location or perceptual properties (or any combination thereof) of one or more of the depicted objects can be changed using conventional methods. These changes can be prescribed or random. In a case where a new object is added to the virtual workspace rendering, it can be an object obtained from an actual image of a robot's workspace, or a synthesized object. Further, the new object can come from a previously-established database of virtual objects. These database objects can also be obtained from actual images of a robot's workspace, or synthesized. The new virtual rendering of the robot's workspace can also be a completely new synthesized workspace depicting either virtual objects derived from actual images of a robot's workspace or synthesized objects that where specifically generated for the new virtual rendering or obtained from database of virtual objects. The use of a new virtual rendering of the robot's workspace for repositioning demonstrations performed after the initial repositioning of one or more of the depicted objects has the advantage of generalizing the resulting robotic control program to never before seen inputs.

### 1.2.1.2 Robotic Control Program Validation

In foregoing implementations, the robotic control program was synthesized and then played virtually for validation by the user. This virtual playback can be implemented using the currently displayed virtual workspace rendering. However, this need not be the case. The virtual playback can also be implemented using a previously-created virtual rendering of the robot's workspace, or a new virtual rendering of the robot's workspace. In the case of a new virtual rendering, it can be obtained in the same ways as described previously.

### 1.2.2 Negative Examples

It was described previously that the robotic control program is synthesized and can then be played virtually for validation by a user. The program was deemed validated if the user was satisfied. However, if the user was not satisfied with the operation of the program, additional repositioning demonstrations could be performed and the program re-synthesized. This would continue until the last-synthesized robotic control program is played and the user is satisfied with its operation. However, in addition to, or instead of, additional repositioning demonstrations being performed, in one implementation, the user can also designate the last-synthesized robotic control program as representing a negative example. In such a case, when the robotic control program is re-synthesized not only are the positive repositioning demonstrations taken into consideration, but also the designated negative examples. As a result, the re-synthesized program will not exhibit the behavior deemed incorrect by the user.

### 1.3 Virtual Workspace Teaching Interface

As described previously, one implementation of the robotic task demonstration interface embodiments described herein involves displaying a virtual rendering of a robot's workspace in which a collection of objects is depicted so as to reflect the orientation, location and perceptual properties characterized found in received object data. Each of the displayed objects from the collection is capable of being repositioned so as to be depicted in a different orientation, or location, or both within the virtual rendering of the workspace. In one implementation, the virtual workspace rendering is part of a virtual workspace training interface that a user can employ to move objects and demonstrate intended actions. To the user, this feels much like reaching into a photograph and manipulating the scene.

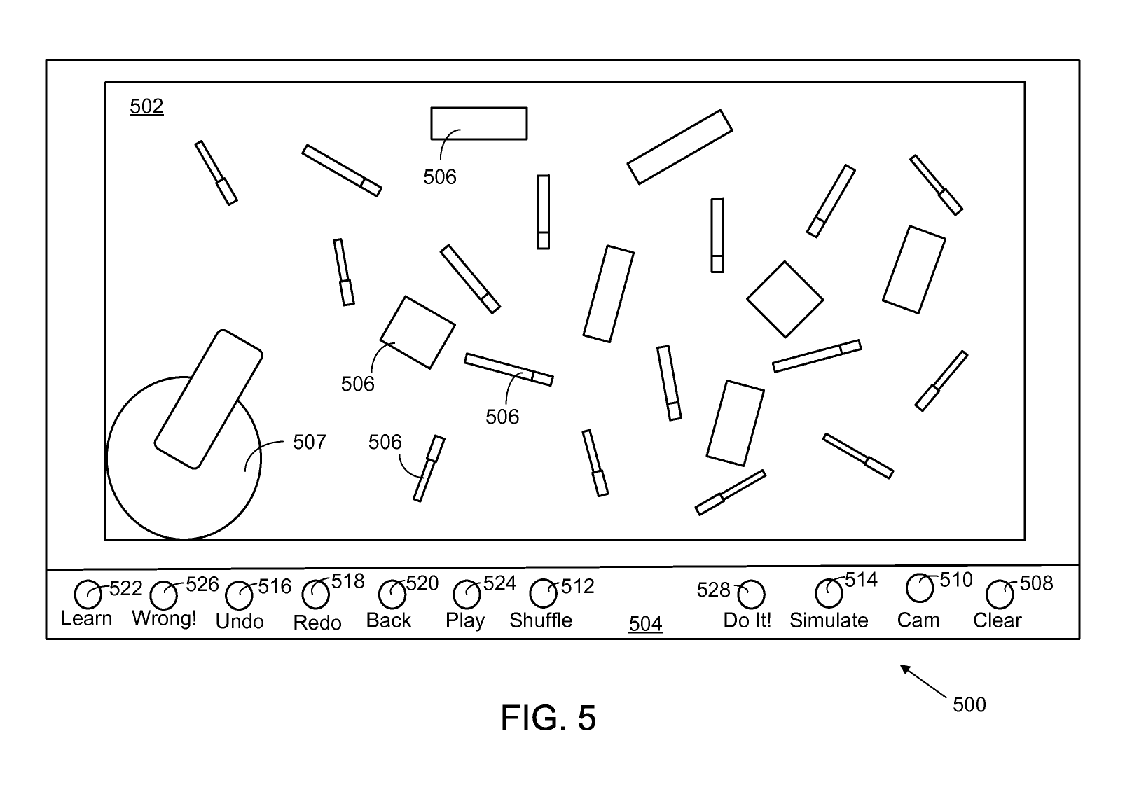

One exemplary implementation of the virtual workspace training interface 500 is shown in FIG. 5. The aforementioned virtual workspace rendering 502 is displayed above a control bar 504. As can be seen, the depicted virtual workspace 502 includes a collection of objects 506. These objects 506 are the repositionable objects described previously. Note that the robot arm 507 shown in the extreme left-hand side of the virtual workspace 502 is part of the workspace background and is not a movable object.

The control bar 504 includes a number of control icons used in the training process. These include a “Clear” button 508 that when selected removes the currently displayed virtual workspace 502 from the interface 500. The “Cam” button 510 is used to input and display a new virtual workspace 502 derived from a currently captured image of the actual robot workspace. The “Shuffle” button 512 rearranges one or more of the displayed objects 506 by moving them to a new location in the virtual workspace 502, or reorienting the pose of an object, or both. Further, a “Simulate” button 514 is included which when selected generates and displays a simulated virtual workspace 502 as described previously.

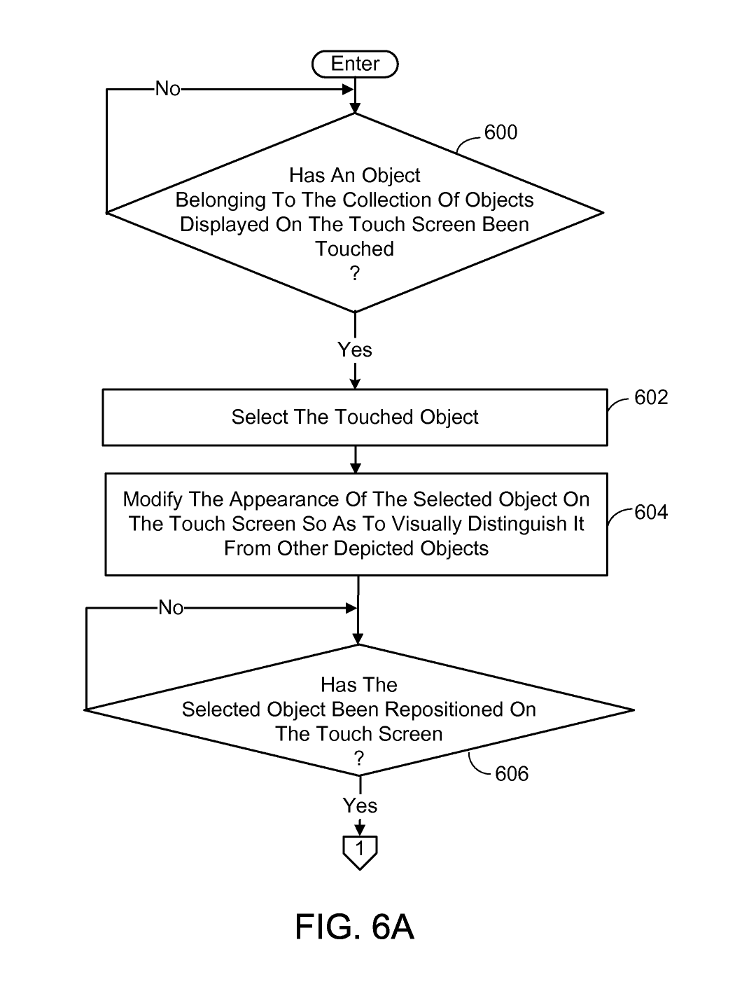

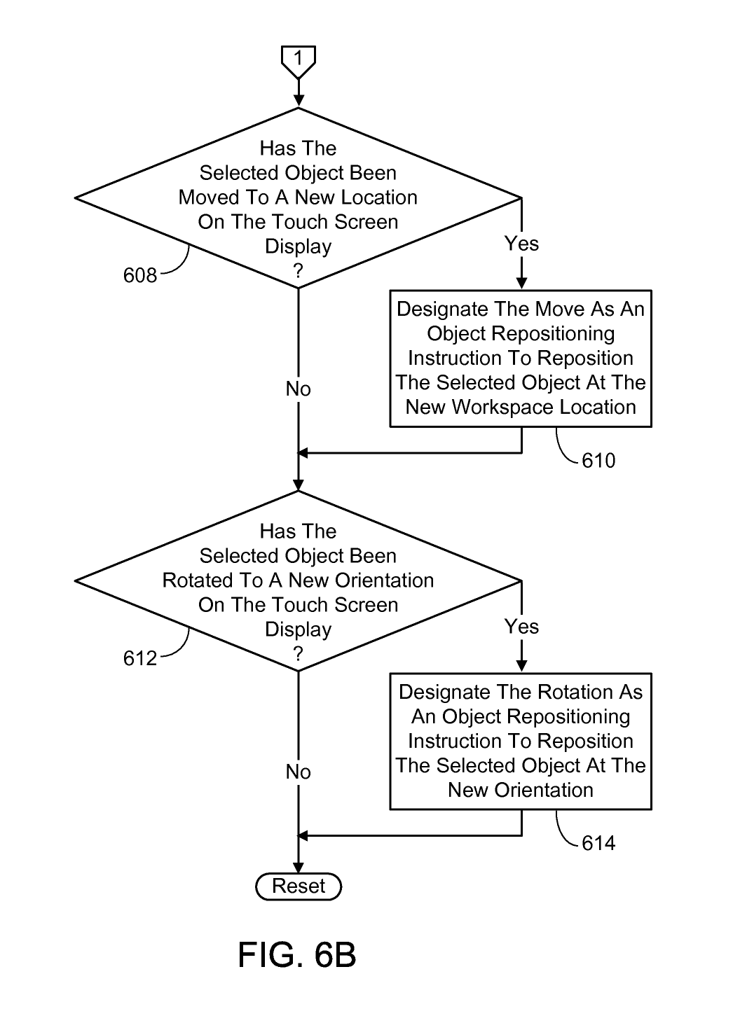

Once a virtual workspace 502 is displayed in the interface 500, the user can manipulate the displayed objects 506 to demonstrate the type of actions the user wishes the synthesized robotic control program to accomplish via the robot. In other words, the user demonstrates examples of the intended actions in order to train the program. As described previously, in one implementation, at least one set of repositioning instructions is generated via the user demonstrating desired movements of one or more objects 506 via the interface 500, before a version of the robotic control program is synthesized. In one implementation this is accomplished via a touch screen. The user employs the touch screen to move objects, and multi-finger touch is employed to control of the pose of each object (e.g., it location and orientation). An object can be moved using one finger, and rotation requires two fingers. This is accomplished even with very tiny objects by first placing one finger on the object to select it, and causing an affordance “patch” to appear around the object. This patch has a size large enough to allow a move or rotation gesture to be performed by the user using one or two fingers. More particularly, referring to FIGS. 6A-B, in one implementation, when it is sensed that an object belonging to the aforementioned collection of objects displayed on the touch screen display has been touched (process action 600), the object is deemed to be selected (process action 602). The appearance of the selected object is then modified on the touch screen display so as to visually distinguish it from other depicted objects (process action 604). For example, in one implementation this is accomplished by having a semitransparent circle appear around the object. Next, it is determined if the selected object has been repositioned on the touch screen (process action 606). If not, the monitoring continues. However, if a repositioning is detected, it is determined if the selected object has been moved to a new location on the touch screen display (process action 608). If so, the move is designated as an object repositioning instruction to reposition the selected object at the new workspace location (process action 610). Whether or not the selected object is moved to a new location, it is next determined if the selected object has been rotated to a new orientation on the touch screen display (process action 612). If so, the rotation is designated as an object repositioning instruction to reposition the selected object at the new orientation (process action 614). Whether or not the selected object is rotated, the process resets and begins again.

Referring again to FIG. 5, icons on the control bar 504 are also used to aid in the demonstration process. For example, the “Undo” button 516 and “Redo” button 518, can be used to, respectively, undo the last demonstrated object repositioning action, or redo the last demonstrated object repositioning action if it was undone. The “Back” button 520 can also be used to return the virtual workspace 502 back to its original configuration should the user want to delete last-performed demonstrations and start over. When the user is through demonstrating the example repositioning actions desired to be associated with one set of repositioning instructions, he or she selects the “Learn” button 522. As indicated previously, the user can perform more demonstrations to create additional sets of instructions. For example, the user might perform additional example demonstrations on a modified or new virtual workspace 502 obtained using the aforementioned “Cam” button 510, or “Shuffle” button 512, or “Simulate” button 514. When the user is ready to synthesize a version of the robotic control program, he or she selects the “Play” button 524. This causes a robotic control program to be synthesized from all the demonstration examples entered by the user. In addition, the synthesized program is virtually executed on the last-generated virtual workspace 502 in its original configuration, and the results displayed. It is noted that if the user wants to assess how the synthesized program will operate on a different workspace configuration than the last one used to enter demonstration examples, he or she can generate a new one in the manner described previously before selecting the “Play” button 524. This allows the user to ensure that the program generalizes to never before seen configurations.

As was described previously, if the last-synthesized program is deemed satisfactory by the user, it is considered validated and the training ends. However, if the user was not satisfied, additional repositioning demonstrations could be performed and the program re-synthesized in the manner described above. This would continue until the last-synthesized robotic control program is played and the user is satisfied with its operation. However, in addition to, or instead of, additional repositioning demonstrations being performed, the user can also designate the last-synthesized robotic control program as representing a negative example. In the example interface of FIG. 5, this is accomplished by selecting the “Wrong!” button 526 after having played the last-synthesized program. When the robotic control program is re-synthesized by again selecting the “Play” button 524, not only are the positive repositioning demonstrations taken into consideration, but also any designated negative examples.

Once the user is satisfied with the last-synthesized robotic control program, he or she can select the “Do it!” button 528 to execute the program against the real world configuration using the actual robot.

### 2.0 Exemplary Operating Environments

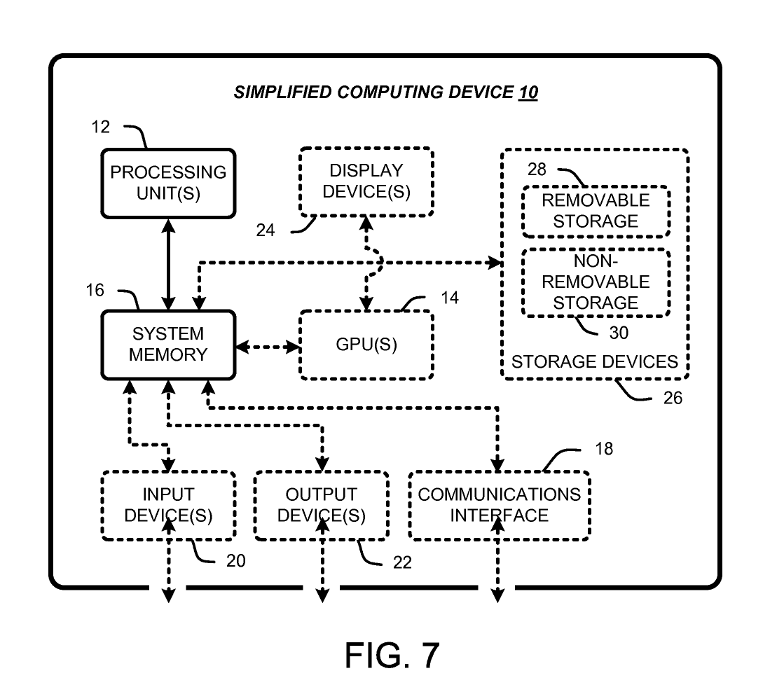

The robotic task demonstration interface embodiments described herein are operational within numerous types of general purpose or special purpose computing system environments or configurations. FIG. 7 illustrates a simplified example of a general-purpose computer system on which various embodiments and elements of the robotic task demonstration interface, as described herein, may be implemented. It is noted that any boxes that are represented by broken or dashed lines in the simplified computing device 10 shown in FIG. 7 represent alternate embodiments of the simplified computing device. As described below, any or all of these alternate embodiments may be used in combination with other alternate embodiments that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to implement the robotic task demonstration interface embodiments described herein, the device should have a sufficient computational capability and system memory to enable basic computational operations. In particular, the computational capability of the simplified computing device 10 shown in FIG. 7 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 shown in FIG. 7 may also include other components such as a communications interface 18. The simplified computing device 10 may also include one or more conventional computer input devices 20 (e.g., pointing devices, keyboards, audio (e.g., voice) input devices, video input devices, haptic input devices, gesture recognition devices, devices for receiving wired or wireless data transmissions, and the like). The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 7 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, program modules, or other data. Computer-readable media includes computer storage media and communication media. Computer storage media refers to tangible computer-readable or machine-readable media or storage devices such as digital versatile disks (DVDs), compact discs (CDs), floppy disks, tape drives, hard drives, optical drives, solid state memory devices, random access memory (RAM), read-only memory (ROM), electrically erasable programmable read-only memory (EEPROM), flash memory or other memory technology, magnetic cassettes, magnetic tapes, magnetic disk storage, or other magnetic storage devices.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various robotic task demonstration interface embodiments described herein, or portions thereof, may be stored, received, transmitted, or read from any desired combination of computer-readable or machine-readable media or storage devices and communication media in the form of computer-executable instructions or other data structures.

Finally, the robotic task demonstration interface embodiments described herein may be further described in the general context of computer-executable instructions, such as program modules, being executed by a computing device. Generally, program modules include routines, programs, objects, components, data structures, and the like, that perform particular tasks or implement particular abstract data types. The robotic task demonstration interface embodiments may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices.

Additionally, the aforementioned instructions may be implemented, in part or in whole, as hardware logic circuits, which may or may not include a processor.

### 3.0 Other Embodiments

It is noted that any or all of the aforementioned embodiments throughout the description may be used in any combination desired to form additional hybrid embodiments. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. In a computer system comprising a user interface and a display device, a computer-implemented process for employing a robotics tasks demonstration interface to synthesize a robotic control program, comprising:
using a computer to perform the following process actions:
receiving object data which represents a collection of objects characterized by their orientation, location and perceptual properties in a workspace associated with a robot;
displaying a virtual rendering of the workspace in which the collection of objects are depicted so as to reflect the orientation, location and perceptual properties characterized in said object data, and in which each object displayed is capable of being repositioned so as to be depicted in a different orientation, or location, or both;
receiving user instructions to reposition one or more of the depicted objects, said object repositioning instructions being indicative of tasks that it is desired for the robot to perform on an object or objects in the actual workspace; and
synthesizing a robotic control program for instructing the robot to perform the tasks indicated in the object repositioning instructions.

2. The process of claim 1, further comprising the process actions of:
virtually executing the synthesized robotic control program to obtain changes in orientation, or location, or both of objects being repositioned by the program; and
displaying a sequence of virtual renderings of the workspace in which objects being repositioned are each shown moving from the object's initial orientation and location to the object's new orientation, or location, or both so as to reflect changes obtained by virtually executing the synthesized robotic control program.

3. The process of claim 2, further comprising the actions of:
receiving a user instruction indicating the changes in orientation, or location, or both of one or more objects as obtained by virtually executing the synthesized robotic control program are correct; and
designating the synthesized robotic control program to be a validated version of the synthesized robotic control program.

4. The process of claim 2, further comprising the actions of:
receiving a user instruction indicating that changes in orientation, or location, or both of one or more objects as obtained by virtually executing the synthesized robotic control program are incorrect;
designating said changes in orientation, or location, or both of one or more objects as obtained by virtually executing the synthesized robotic control program indicated as being incorrect as a negative change example;
generating negative repositioning instructions for the negative change example, said negative repositioning instructions being indicative of tasks that it is not desired for the robot to perform on an object or objects in the actual workspace; and
synthesizing a revised robotic control program for instructing the robot to perform the tasks indicated in the previously-received object repositioning instructions and not the tasks indicated in the negative prepositioning instructions.

5. The process of claim 1, further comprising the actions of:
displaying a new virtual rendering of the workspace in which the same or a modified collection of objects characterized by their orientation, location and perceptual properties are depicted;
receiving additional user instructions to reposition one or more of the objects depicted in the new virtual rendering of the workspace, said object repositioning instructions being indicative of tasks that it is desired for the robot to perform on an object or objects in the actual workspace; and
synthesizing a revised robotic control program for instructing the robot to perform the tasks indicated in the additional object repositioning instructions and the last, previously-received object repositioning instructions.

6. The process of claim 5, further comprising the process actions of:
virtually executing the revised synthesized robotic control program to obtain changes in orientation, or location, or both of objects being repositioned by the program; and
displaying a sequence of virtual renderings of the workspace in which objects being repositioned are each shown moving from the object's initial orientation and location to the object's new orientation, or location, or both so as to reflect changes obtained by virtually executing the revised synthesized robotic control program.

7. The process of claim 6, further comprising the actions of:
receiving a user instruction indicating the changes in orientation, or location, or both of one or more objects as obtained by virtually executing the revised synthesized robotic control program are correct; and
designating the revised synthesized robotic control program to be a new validated version of the synthesized robotic control program.

8. The process of claim 6, further comprising the actions of:
receiving a user instruction indicating that changes in orientation, or location, or both of one or more objects as obtained by virtually executing the revised synthesized robotic control program are incorrect;
designating said changes in orientation, or location, or both of one or more objects as obtained by virtually executing the revised synthesized robotic control program indicated as being incorrect as a negative change example;
generating negative repositioning instructions for the negative change example, said negative repositioning instructions being indicative of tasks that it is not desired for the robot to perform on an object or objects in the actual workspace; and
synthesizing a further revised robotic control program for instructing the robot to perform the tasks indicated in the previously-received object repositioning instructions and not the tasks indicated in the negative prepositioning instructions.

9. The process of claim 5, wherein the process action of displaying a new virtual rendering of the workspace, comprises an action of changing the orientation, or location, or both of at least one object in said collection of objects depicted in the last, previously displayed virtual rendering of the workspace.

10. The process of claim 5, wherein the process action of displaying a new virtual rendering of the workspace, comprises the actions of:
receiving new object data which represents the modified collection of objects characterized by their orientation, location and perceptual properties as depicted in an image of an actual workspace associated with a robot; and
displaying the new virtual rendering of the workspace in which the modified collection of objects are depicted so as to reflect the orientation, location and perceptual properties characterized in said new object data, and in which each object displayed is capable of being repositioned so as to be depicted in a different orientation, or location, or both.

11. In a computer system comprising a user interface and a display device, a computer-implemented process for employing a robotics tasks demonstration interface to synthesize a robotic control program, comprising:
using a computer to perform the following process actions:
receiving object data which represents a collection of objects characterized by their orientation, location and perceptual properties in a workspace associated with a robot;
displaying a virtual rendering of the workspace in which the collection of objects are depicted so as to reflect the orientation, location and perceptual properties characterized in said object data, and in which each object displayed is capable of being repositioned so as to be depicted in a different orientation, or location, or both;
receiving user instructions to reposition one or more of the depicted objects, said object repositioning instructions being indicative of tasks that it is desired for the robot to perform on an object or objects in the actual workspace;
displaying a new virtual rendering of the workspace in which the same or a modified collection of objects characterized by their orientation, location and perceptual properties are depicted;
receiving additional user instructions to reposition one or more of the objects depicted in the new virtual rendering of the workspace, said object repositioning instructions being indicative of tasks that it is desired for the robot to perform on an object or objects in the actual workspace; and
synthesizing a robotic control program for instructing the robot to perform the tasks indicated in the additional object repositioning instructions and previously-received object repositioning instructions.

12. The process of claim 11, wherein the process action of displaying a new virtual rendering of the workspace, comprises an action of changing the orientation, or location, or both of at least one object in said collection of objects depicted in the previously displayed virtual rendering of the workspace.

13. The process of claim 11, wherein the process action of displaying a new virtual rendering of the workspace, comprises the actions of:
receiving new object data which represents the modified collection of objects characterized by their orientation, location and perceptual properties as depicted in an image of an actual workspace associated with a robot; and
displaying the new virtual rendering of the workspace in which the modified collection of objects are depicted so as to reflect the orientation, location and perceptual properties characterized in said new object data, and in which each object displayed is capable of being repositioned so as to be depicted in a different orientation, or location, or both.

14. The process of claim 11, further comprising the process actions of:
virtually executing the synthesized robotic control program to obtain changes in orientation, or location, or both of objects being repositioned by the program; and
displaying a sequence of virtual renderings of the workspace in which objects being repositioned are each shown moving from the object's initial orientation and location to the object's new orientation, or location, or both so as to reflect changes obtained by virtually executing the synthesized robotic control program.

15. The process of claim 14, further comprising the actions of:
receiving a user instruction indicating the changes in orientation, or location, or both of one or more objects as obtained by virtually executing the synthesized robotic control program are correct; and
designating the synthesized robotic control program to be a validated version of the synthesized robotic control program.

16. The process of claim 14, further comprising the actions of:
receiving a user instruction indicating that changes in orientation, or location, or both of one or more objects as obtained by virtually executing the synthesized robotic control program are incorrect;
designating said changes in orientation, or location, or both of one or more objects as obtained by virtually executing the synthesized robotic control program indicated as being incorrect as a negative change example;
generating negative repositioning instructions for the negative change example, said negative repositioning instructions being indicative of tasks that it is not desired for the robot to perform on an object or objects in the actual workspace; and
synthesizing a revised robotic control program for instructing the robot to perform the tasks indicated in the previously-received object repositioning instructions and not the tasks indicated in the negative prepositioning instructions.

17. A system for synthesizing a robotic control program, comprising:
a computing device comprising a touch screen display; and
a robotics tasks demonstration interface computer program having program modules executable by the computing device, the computing device being directed by the program modules of the computer program to,
receive object data which represents a collection of objects characterized by their orientation, location and perceptual properties in a workspace associated with a robot,
display on said touch screen display a virtual rendering of the workspace in which the collection of objects are depicted so as to reflect the orientation, location and perceptual properties characterized in said object data, and in which each object displayed is capable of being repositioned via a touch gesture on the touch screen display so as to be depicted in a different orientation, or location, or both,
receive user instructions via the touch screen display to reposition one or more of the depicted objects, said object repositioning instructions being indicative of tasks that it is desired for the robot to perform on an object or objects in an actual workspace, and
synthesize a robotic control program for instructing the robot to perform the tasks indicated in the object repositioning instructions.

18. The system of claim 17, wherein the program module for receiving user instructions via the touch screen display, comprises sub-modules for:
sensing when an object belonging to said collection of objects displayed on the touch screen display has been touched and deeming the object to have been selected;
modifying the appearance of the selected object so as to visually distinguish it from other depicted objects;
whenever it is sensed that the selected object has been moved to a new location on the touch screen display, deeming the move to be an object repositioning instruction to reposition the selected object at said new location; and
whenever it is sensed that the selected object has been rotated to a new orientation on the touch screen display, deeming the rotation to be an object repositioning instruction to reposition the selected object at said new orientation.

19. The system of claim 17, wherein the workspace is either an image of an actual workspace associated with a robot, or a synthesized workspace.

20. The system of claim 17, wherein one or more of the objects in said collection of objects is either an actual object found in an image of an actual workspace associated with a robot, or an virtual object obtained from a database of virtual objects.
